(19) United States
(12) Patent Application Publication
(10) Pub. No.: US 2007/0046853 A1
(43) Pub. Date: Mar. 1, 2007

(54) Liquid crystal display

(75) Inventors: Yoon-soo Kwon, Anyang-si (KR); Jung-tae Kang, Suwon-si (KR); Sang-hoon Park, Yongin-si (KR); Jin-ho Ha, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/508,043

(22) Filed: Aug. 22, 2006

(30) Foreign Application Priority Data
Aug. 24, 2005 (KR) 2005-77602

(51) Int. Cl. G02F 1/1333

(52) U.S. Cl. 349/58

(57) ABSTRACT

An LCD comprises an LCD panel, and a surface light source comprising a lower substrate and an upper substrate which are combined with each other behind the LCD panel. The surface light source has an edge combining area provided along edges of the upper and the lower substrates. The LCD includes a side mold disposed at at least one side of the surface light source and supporting at least a portion of the edge combining area. The LCD exhibits enhanced impact resistance.

### CROSS-REFERENCE TO RELATED APPLICATION

This application claims the benefit of Korean Patent Application No.2005-0077602, filed on Aug. 24, 2005, the contents of which are incorporated herein by reference in their entirety.

### BACKGROUND OF THE INVENTION

1. Technical Field

The present disclosure relates to a liquid crystal display (LCD) using a surface light source, and more particularly to an LCD comprising a side mold having a structure which protects the surface light source from external impact.

2. Discussion of the Related Art

An LCD may comprise an LCD panel, a backlight unit providing light to the rear of the LCD panel and a side mold fixing or supporting the backlight unit. Transmittance of the light from the backlight unit is controlled depending on an arrangement of liquid crystals, thereby forming an image on the LCD panel.

The backlight unit may comprise an optical member disposed in behind the LCD panel and a light source irradiating light to the LCD panel. A cold cathode fluorescent lamp (CCFL), an external electrode fluorescent lamp (EEFL), or a flat fluorescent lamp (FFL) of a surface light source, for example, can be used as a light source. A surface light source has high brightness and brightness uniformity and a long life and consumes low electricity when compared with other light sources. Further, the surface light source does not require a light guiding plate and a reflecting plate, thereby reducing a manufacturing cost. Therefore, the surface light source has been widely employed.

The surface light source comprises a lower glass substrate and an upper glass substrate. The lower glass substrate is flat and the upper glass substrate comprises convex light emitting parts and flat partitioning parts which are alternately disposed.

The surface light source is made of glass, and is therefore fragile against an external impact. In an effort to prevent damage to the surface light source, the surface light source is fixed on side edges of the surface light source by using a side mold. The side mold comprises a surface light source supporter with a wave pattern corresponding to the light emitting parts and the partitioning parts.

However, the surface light source fixed by the conventional side mold does not adequately absorb external impact even though fixed on the sides edges thereof, and impact resistance of the surface light source remains insufficient.

### SUMMARY OF THE INVENTION

In accordance with an embodiment of the present invention, an LCD comprises an LCD panel, and a surface light source comprising a lower glass substrate and an upper glass substrate which are combined each other behind the LCD panel. The surface light source includes an edge combining area provided along edges of the upper glass substrate and the lower glass substrate. The LCD further comprises a side mold disposed at at least a side of the surface light source and supporting at least a portion of the edge combining area.

The lower glass substrate may be flat and the upper glass substrate may comprise a convex light emitting part extended in a lengthwise direction along a surface of the upper glass substrate and a flat partitioning part disposed adjacent to the light emitting part, the convex light emitting part and the flat partitioning part being disposed alternately.

A height of the edge combining area may be less than a height of the light emitting part.

The LCD may further comprise an accommodating container comprising a bottom where the surface light source is received and a lateral wall which is extended and bent from the bottom toward the LCD panel to form an accommodating space accommodating the surface light source, wherein the side mold comprises a main body at least partly supported by the lateral wall and a supporting part protruded from the main body toward the edge combining area to support the edge combining area.

An end portion of the supporting part contacting the edge combining area may comprise an elastic material.

The surface light source may have a rectangular shape and comprise an edge combining area on each edge thereof, and at least two supporting parts can support edge combining areas disposed at opposite ends of the light emitting part.

The side mold may further comprise a reflecting part extended downward from and inclined at a predetermined angle with respect to the main body. The reflecting part can be spaced from the surface light source at an end portion thereof.

A reflecting layer may be formed on at least a portion of the surface of the reflecting part.

A plurality of side molds can be respectively disposed at opposite ends of a lengthwise direction of the light emitting part.

The LCD may further comprise an optical member disposed between the LCD panel and the surface light source, wherein the side mold further comprises a supporting surface disposed between the main body and the reflecting part and supporting edges of the optical member.

The LCD may further comprise light source supporting members disposed in corners of the accommodating container to support the surface light source, wherein the side mold further comprises a fixing part extended from the main body toward the light source supporting member. The fixing part may be substantially parallel to the supporting part.

At least two side molds may be respectively disposed at opposite sides of an arrangement direction of the light emitting part.

A liquid crystal display (LCD), in accordance with an embodiment of the present invention, comprises a light source comprising a lower substrate and an upper substrate, wherein the lower and the upper substrates are combined with each other, and a side mold disposed at at least one side of the light source and supporting at least a portion of the light source. The side mold comprises a main body substantially parallel to a top surface of the light source, and a supporting part protruded downward from the main body in a direction substantially perpendicular to the main body, wherein the supporting part supports the light source at an edge portion thereof.

The supporting part may comprise an elastic material.

### BRIEF DESCRIPTION OF THE DRAWINGS

Exemplary embodiments of the present invention can be understood in more detail from the following description taken in conjunction with the accompanying drawings of which:

FIG. 1 is an exploded perspective view of an LCD according to an embodiment of the present invention;

FIG. 2 is a sectional view of the LCD according to an embodiment of the present invention; and

FIG. 3 is a perspective view of a part of an LCD according to an embodiment of the present invention.

### DETAILED DESCRIPTION OF THE EXEMPLARY EMBODIMENTS

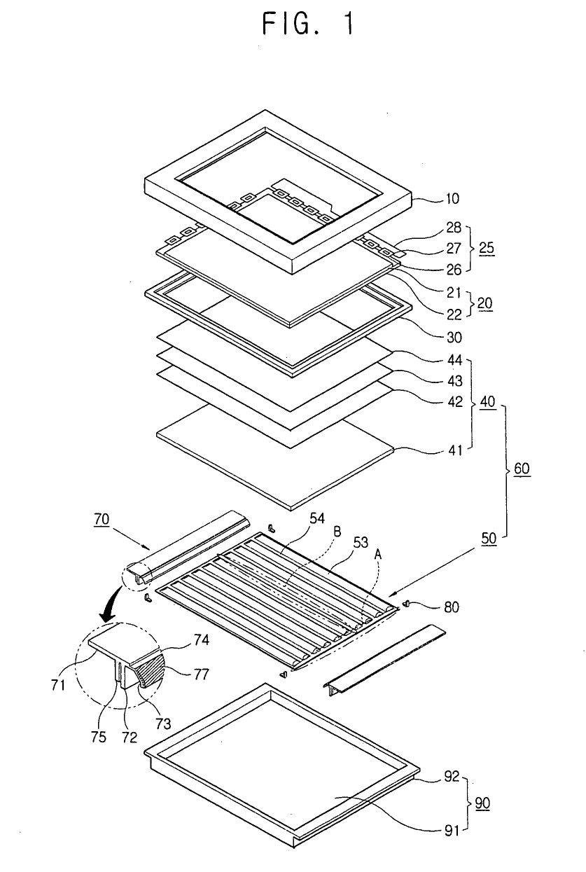

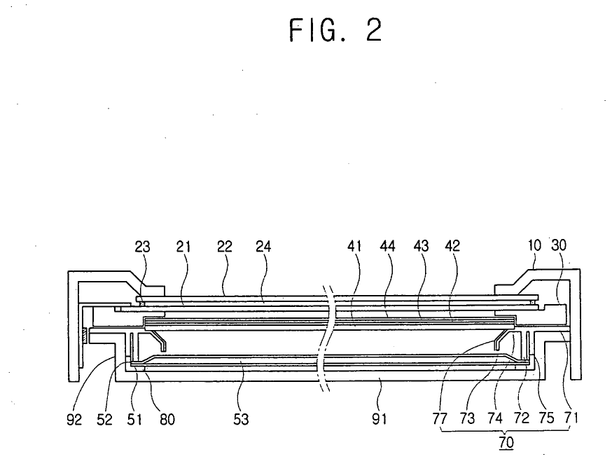

Exemplary embodiments of the present invention will now be described more fully hereinafter below in more detail with reference to the accompanying drawings. This invention may, however, be embodied in different forms and should not be construed as limited to the embodiments set forth herein. Referring to FIGS. 1 and 2, an LCD according to a an embodiment of the present invention comprises an LCD panel 20, an optical member 40 disposed behind the LCD panel 20, a surface light source 50 providing light to the rear of the optical member 40 and a side mold 70 supporting edges of the optical member 40 and fixing the surface light source 50. The LCD panel 20, the optical member 40 and the surface light source 50 are accommodated in a casing member 10 and an accommodating container 90.

The LCD panel 20 comprises a thin film transistor (TFT) substrate 21 where TFTs are formed, a color filter substrate 22 facing the TFT substrate 21, a sealant 23 adhering both substrates 21 and 22 to each other and forming a cell gap therebetween. A liquid crystal layer 24 is disposed between both substrates 21 and 22 and the sealant 23. The LCD panel 20 adjusts an arrangement of the liquid crystal layer 24, thereby forming images. The LCD panel 20 does not emit light by itself, and thus the surface light source 50 is disposed behind the LCD panel 20 to provide light.

A driving part 25 applying a driving signal is provided at a side of the TFT substrate 21. The driving part 25 comprises a flexible printed circuit (FPC) 26, a driving chip 27 mounted on the FPC 26 and a printed circuit board (PCB) 28 connected to one side of the FPC 26. The driving part 25 shown in FIG. 2 is a chip on film (COF) type. Alternatively, a tape carrier package (TCP), a chip on glass (COG) or the like, may be used. Further, the driving part 25 may be formed on the TFT substrate 21 during a wiring process.

A mold frame 30 of a substantially rectangular shape is formed along edges of the LCD panel 20 to support the LCD panel 20. The mold frame 30 spaces the LCD panel 20 and the backlight unit 60 from each other.

A backlight unit 60 disposed behind the LCD panel 20 comprises the optical member 40 and the surface light source 50.

The optical member 40 according to an embodiment of the present invention comprises a diffusion plate 41 and a diffusion film 42, a prism film 43 and a protection film 44 which are disposed on the diffusion plate 41. The diffusion plate 41 has a predetermined thickness to prevent the diffusion film 42, the prism film 43 and the protection film 44 from sagging. The diffusion plate 41 diffuses or disperses light radiated from the surface light source 50. A light dispersion part of a convex shape may further be provided on one side of the diffusion plate 41. The diffusion film 42 comprises a base plate. A coating layer having beads is formed on the base plate. Two or three diffusion films 42 may be used, wherein the two or three diffusion films 42 are layered. The diffusion film 42, along with the diffusion plate 41, diffuses light from the surface light source 50 and provides the light to the LCD panel 20, thereby improving brightness uniformity. The prism film 43 comprises triangular prisms formed in a predetermined arrangement thereon. The prism film 43 collects the light diffused from the diffusion film 42 perpendicularly to a surface of the LCD panel 20. Typically, two prism films 43 are used and micro prisms formed on each of the prism films 43 form predetermined angles with respect to each other. The light passing through the prism film 43 mostly continues perpendicularly with respect to the prism film, thereby forming a uniform brightness distribution. The protection film 44 disposed at the top of the optical member 40 protects the prism film 43, which is vulnerable to scratching.

The surface light source 50 comprises a lower glass substrate 51 and an upper glass substrate 52. The lower glass substrate 51 is flat and the upper glass substrate 52 comprises a convex light emitting part 53 formed in a lengthwise direction along a surface of the substrate. The upper glass substrate 52 also comprises a flat partitioning part 54 connected to the light emitting part 53. The convex light emitting part 53 and the flat partitioning part 54 are alternately disposed. That is, the upper glass substrate 52 is formed in a wave shape and comprises the partitioning part 54 disposed between the adjacent light emitting parts 53. The partitioning part 54 of the upper glass substrate 52 supports the light emitting part 53 while contacting the lower glass substrate 51.

A sectional view of the surface light source 50 taken along an arrangement direction of the light emitting parts 53 (perpendicular to the lengthwise direction) is a half circle shape protruded toward the LCD panel 20 (see FIG. 1) and a sectional view of the surface light source 50 taken along a lengthwise direction of the light emitting part 53 is a trapezoid shape (see FIG. 2).

The lower glass substrate 51 and the upper glass substrate 52 comprise an edge combining area A where both substrates 51, 52 are combined along edges thereof and a partitioning part combining area B where both substrates 51, 52 are combined along the partitioning area 54. The convex light emitting part 53 is sealed by the edge combining area A and the partitioning part combining area B.

At least one of the lower substrate 51 and the upper substrate 52 is applied with a fluorescent substance. The light emitting part 53 is filled with light emitting gas comprising mercury or neon. There is no light emitting gas in the partitioning part 54. As a result, the partitioning part 54 does not generate light.

The side mold 70 comprises a main body 71, a supporting part 72, a reflecting part 73 and a supporting surface 74. The main body 71 is disposed substantially parallel with the LCD panel 20. The supporting part 72 is protruded toward the edge combining area A from the main body 71 to support the edge combining area A. The reflecting part 73 is extended from the main body 71 downward, inclining at a predetermined angle. The reflecting part 73 is spaced from the surface light source 50 at an end portion thereof. The supporting surface 74 is provided on an area where the main body 71 is connected to the reflecting part 73 (e.g., between the main body 71 and the reflecting part 73) and supports an edge of the optical member 40. The side mold 70 is disposed at opposite ends along a lengthwise direction of the light emitting part 53.

The main body 71 is formed along at least one lateral wall 92 of the accommodating container 90. For example, the main body 71 is formed along the two lateral walls 92 disposed at opposite ends of the lengthwise direction of the light emitting part 53. The four lateral walls 92 are formed at right angles to each other to form an accommodating container 90 in a substantially rectangular shape. Further, the main body 71 is, at least partly, supported by the lateral wall 92.

The supporting part 72 is extended toward the edge combining area A from the main body 71 and contacts the edge of the combining area A at an end thereof.

A supporting part may comprise a wave-shaped part and a flat part, wherein the wave-shaped part contacts the partitioning part 54 at least partly, thereby supporting a surface light source 50 in a lengthwise direction of the light emitting part. The flat part supports the surface light source 50 in an arrangement direction of the light emitting part. However, when using a supporting part having wave-shaped and flat parts, the surface light source 50 is not flexible against external impact, and thus exhibits low impact resistance.

In contrast, the supporting part 72 according to an embodiment of the present invention contacts the edge combining area A, where the lower glass substrate 51 is combined with the upper glass substrate 52, along the edge of the surface light source 50. As a result, the degree of freedom of the surface light source 50 is enhanced such that the surface light source is better able to absorb external impact. In other words, the surface light source 50 is supported by the supporting part 72 only on the edge combining area A thereof corresponding to the opposite ends of the lengthwise direction of the light emitting part 53. As a result, the surface light source is flexible against external impact. Also, an end portion of the supporting part 72 is formed of a soft or elastic material, thereby enhancing the impact resistance. The elastic material may be, for example, silicon polymer or organic polymer.

The reflecting part 73 is extended from the main body 71 downward and is inclined at a predetermined angle. The reflecting part 73 is spaced from the surface light source 50 at the end portion thereof. That is, unlike an end portion of the supporting part having the wave-shaped and flat parts, the end portion of the reflecting part 73 is spaced from the surface light source 50. The reflecting part 73 reflects the light irradiated from the surface light source 50 to the LCD panel 20, to thereby enhance light efficiency. The reflecting part 73 comprises a reflecting layer 77 on at least a portion of a surface thereof so as to evenly distribute light and enhance the light efficiency.

The supporting surface 74 is provided on an area where the main body 71 is connected to the reflecting part 73. The supporting surface 74 supports the edge of the optical member 40 with a height lower than the main body 71.

The side mold 70 may further comprise a fixing part 75 extended from the main body 71 toward a light source supporting member 80. The fixing part extends substantially parallel to the supporting part 72. The fixing part 75 allows the main body 71 to be fixed to and supported by the lateral wall 92 of the accommodating container 90. Like the supporting part 72, the fixing part 75 may be extended along the lateral wall 92. Alternatively, a portion of the fixing part 75 may be removed, such that the fixing part 75 does not fully extend along the lateral wall 92.

The light source supporting members 80 are disposed in corners of the accommodating container 90 to support the surface light source 50. The light source supporting member 80 comprises a soft material, e.g. silicon rubber, which is capable of absorbing an impact. Also, the light source supporting member 80 serves as an insulator and reduces electrical interference between the accommodating container 90 and the surface light source 50.

The accommodating container 90 comprises a flat underside 91 and the lateral walls 92 extended from the underside 91 toward the LCD panel to form an accommodating space accommodating the surface light source 50. As shown in FIG. 1, the lateral walls 92 may be bent to support the main body 71.

The accommodating container 90 is combined with the casing member 10, thereby accommodating the LCD panel 20 and the backlight unit 60 therein.

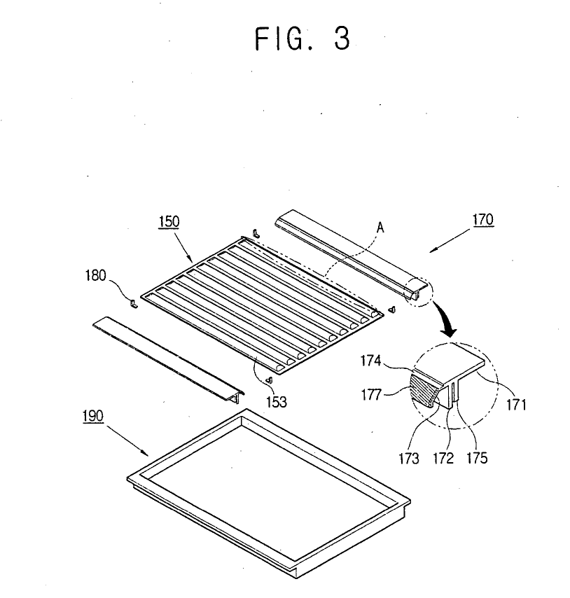

Hereinafter, another embodiment of the present invention will be described referring to FIG. 3.

As shown in FIG. 3, side molds 170 are disposed at opposite ends of an arrangement direction of a light emitting part 153, i.e., substantially parallel to the lengthwise direction of the light emitting part 153, so that at least a portion of a supporting part 172 supports an edge combining area A that is disposed on the edge of the light emitting part 153 and is substantially parallel to the lengthwise direction of the light emitting part 153. A reflecting part 173 is disposed near the light emitting part 153, which is adjacent to the edge combining area A, thereby reflecting light irradiated from the light emitting part 153 to improve light efficiency. Accordingly, a degree of freedom of the surface light source 150 increases, such that the surface light source 150 is flexible against external impact and impact resistance is improved.

Reference numerals 171, 174, 175, 177, 180 and 190 denote components corresponding to the components given reference numerals 71, 74, 75, 77, 80 and 90 in the embodiment described in connection with FIG. 1.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A liquid crystal display (LCD) comprising:
an LCD panel;
a surface light source comprising:
a lower substrate and an upper substrate, wherein the lower and the upper substrates are combined with each other behind the LCD panel; and
an edge combining area provided along edges of the upper and the lower substrates; and
a side mold disposed at at least one side of the surface light source and supporting at least a portion of the edge combining area.

2. The LCD according to claim 1, wherein the lower substrate is flat and the upper substrate comprises:
a light emitting part extended in a direction along a surface of the upper substrate; and
a partitioning part disposed adjacent to the light emitting part, the light emitting part and the partitioning part being disposed alternately.

3. The LCD according to claim 2, wherein a height of the edge combining area is less than a height of the light emitting part.

4. The LCD according to claim 2, wherein the light emitting part is convex and the partitioning part is flat.

5. The LCD according to claim 1, further comprising a container comprising a bottom where the surface light source is received and a lateral wall extended and bent from the bottom toward the LCD panel to form a space accommodating the surface light source, wherein the side mold comprises a main body supported at least in part by the lateral wall.

6. The LCD according to claim 5, wherein the side mold further comprises a supporting part protruded from the main body toward the edge combining area to support the edge combining area.

7. The LCD according to claim 6, wherein a portion of the supporting part contacting the edge combining area comprises an elastic material.

8. The LCD according to claim 6, wherein:
the surface light source has a rectangular shape and comprises an edge combining area on each of a plurality of edges, and
at least two supporting parts support edge combining areas disposed at opposite ends of the light emitting part.

9. The LCD according to claim 5, wherein the side mold further comprises a reflecting part extended downward from and inclined at a predetermined angle with respect to the main body.

10. The LCD according to claim 9, wherein the reflecting part is spaced from the surface light source.

11. The LCD according to claim 9, wherein a reflecting layer is formed on at least a portion of a surface of the reflecting part.

12. The LCD according to claim 8, wherein a plurality of side molds are respectively disposed at opposite ends of a lengthwise direction of the light emitting part.

13. The LCD according to claim 9, further comprising an optical member disposed between the LCD panel and the surface light source, wherein the side mold further comprises a supporting surface disposed between the main body and the reflecting part, the supporting surface supporting an edge of the optical member.

14. The LCD according to claim 6, further comprising light source supporting members disposed in corners of the container to support the surface light source, wherein the side mold further comprises a fixing part extended from the main body toward the light source supporting member, the fixing part being substantially parallel to the supporting part.

15. The LCD according to claim 5, wherein at least two side molds are respectively disposed at opposite sides of an arrangement direction of the light emitting part.

16. A liquid crystal display (LCD) comprising:
a light source comprising a lower substrate and an upper substrate, wherein the lower and the upper substrates are combined with each other; and
a side mold disposed at at least one side of the light source and supporting at least a portion of the light source, wherein the side mold comprises:
a main body substantially parallel to a top surface of the light source; and
a supporting part protruded downward from the main body in a direction substantially perpendicular to the main body, wherein the supporting part supports the light source at an edge portion thereof.

17. The LCD according to claim 16, wherein the supporting part comprises an elastic material.
